(19) United States
(12) Patent Application Publication
(10) Pub. No.: US 2016/0012704 A1
(43) Pub. Date: Jan. 14, 2016

(54) Object Detector and Method

(71) Applicant: ROKE MANOR RESEARCH LIMITED, Romsey Hampshire (GB)

(72) Inventors: Tony McDonald, Romsey Hampshire (GB); Julian Gannaway, Romsey Hampshire (GB)

(21) Appl. No.: 14/713,581

(22) Filed: May 15, 2015

(30) Foreign Application Priority Data
May 16, 2014 (GB) 1408730.8

(51) Int. Cl. G08B 21/18; G08B 3/00

(52) U.S. Cl. CPC G08B 21/18; G08B 3/00

(57) ABSTRACT

An object detector for detecting elongate conductive objects, comprising: a transmitter arranged to generate a transmit signal; and a transmit antenna, coupled to said transmitter and arranged to radiate said transmit signal; wherein the object detector is arranged to generate a detection signal, the detection signal being based on at least one characteristic of a portion of the transmit signal reflected by the transmit antenna; and the at least one characteristic of the portion of the transmit signal reflected by the transmit antenna changes in response to movement of the detector in relation to a detectable object.

### CROSS REFERENCE TO RELATED APPLICATION

This application claims priority from United Kingdom Patent Application No. 1408730.8, filed May 16, 2014, the entire contents of which is incorporated herein by reference.

### FIELD

The present disclosure relates to an object detector and method. In particular, embodiments of the present disclosure relate to an object detector which is suitable for detecting buried elongate conductive objects, and a corresponding method.

### BACKGROUND

Detectors suitable for detecting buried objects are well-known in the art. For example, pending UK patent application number 1402817.9, in the name of Roke Manor Research Limited, discloses a detector of buried elongate conductive objects, which includes two loop antennas. It is useful when undertaking ground works of any kind, for example, whether it be for utility use, farming, geological, archaeological or other purposes, to know of any existing infrastructure, for example pipes and cables buried in the ground. There is a particular need for detectors which could operate over a range of several metres. Longer detection range means that less surveying time is required for a given area of ground. Furthermore, there is a need for detectors which are less susceptible to electromagnetic interference and which are more reliable in operation, and reduce the probability of false detections.

It is an object of the present disclosure to provide an object detector which addresses the aforementioned issues.

### SUMMARY

A first aspect of the present disclosure provides an object detector for detecting elongate conductive objects, comprising: a transmitter arranged to generate a transmit signal; and a transmit antenna, coupled to said transmitter and arranged to radiate said transmit signal; wherein the object detector is arranged to generate a detection signal, the detection signal being based on at least one characteristic of a portion of the transmit signal reflected by the transmit antenna; and the at least one characteristic of the portion of the transmit signal reflected by the transmit antenna changes in response to movement of the detector in relation to a detectable object.

A second aspect of the present disclosure provides a method of elongate conductive object detection using an object detector comprising: a transmitter arranged to generate a transmit signal; and a transmit antenna, coupled to said transmitter and arranged to radiate said transmit signal; the method comprising: generating and transmitting said transmit signal; generating a detection signal, the detection signal being based on at least one characteristic of a portion of the transmit signal reflected by the transmit antenna; wherein the at least one characteristic of the portion of the transmit signal reflected by the transmit antenna changes in response to movement of the detector in relation to a detectable object.

Further features of embodiments are recited in the appended claims.

### BRIEF DESCRIPTION OF THE DRAWINGS

The present embodiments will now be described, by way of example only, and with reference to the accompanying drawings in which:

FIG. 1 is a schematic diagram of an object detector in accordance with a first embodiment;

FIG. 2 is a plot showing reflected signal power against time for the object detector shown in FIG. 1;

FIG. 3 is a schematic diagram of an object detector in accordance with a second embodiment;

FIG. 4 is a schematic diagram of an object detector in accordance with a third embodiment;

FIG. 5 is a schematic diagram of an object detector in accordance with a fourth embodiment; and

FIG. 6 is a plan view of the detector of any of embodiments one to four in use.

### DETAILED DESCRIPTION

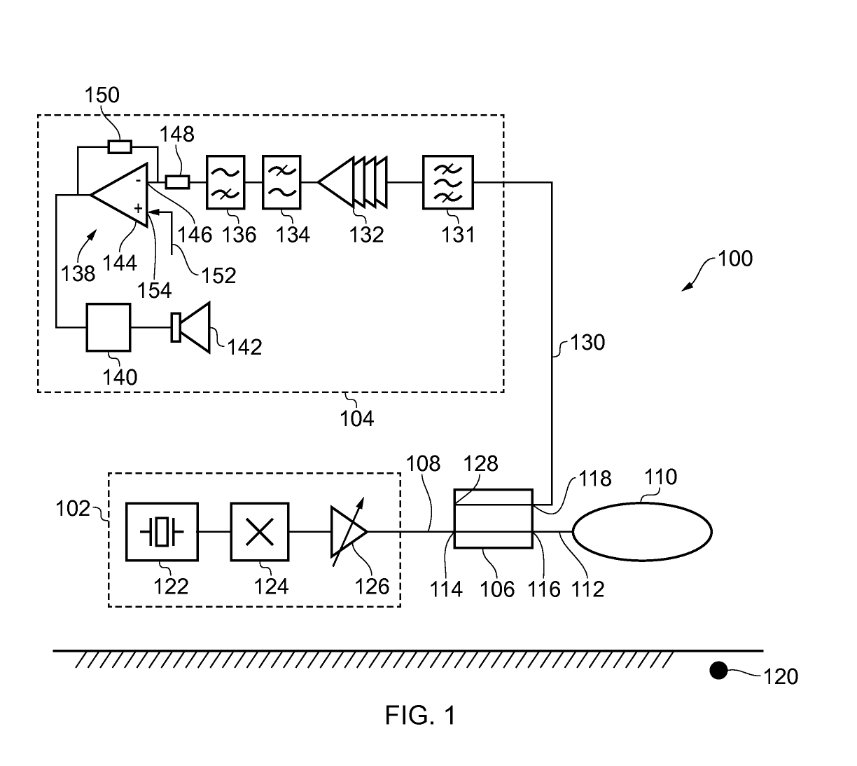

FIG. 1 is a schematic diagram of an object detector 100 in accordance with a first embodiment. The object detector 100 includes a transmitter subsystem 102, and a detector subsystem 104.

An output of the transmitter subsystem 102 is coupled to a directional coupler 106, via transmission line 108, which is in turn coupled to a transmit loop antenna 110, via transmission line 112. The directional coupler 106 includes an input port 114 and an output port 116. The output of the transmitter subsystem 102 is coupled to the input port 114 of the directional coupler 106. The transmit loop antenna 110 is coupled to the output port 116 of the directional coupler 106. The directional coupler 106 also includes a reflected power port 118. The detector subsystem 104 is coupled to the reflected power port 118 of the directional coupler 106, as will be described in more detail below.

Transmit loop antenna 110 is arranged in the horizontal plane, i.e. the plane of the loop of the antenna is parallel to the surface of the ground surface. Furthermore, the loop is circular when viewed from above. However, other configurations are possible, as will be appreciated by the skilled person.

The transmitter subsystem 102 includes an oscillator 122 and a frequency multiplier 124. The transmit signal is generated by oscillator 122 and frequency multiplier 124. The oscillator 122 and frequency multiplier 124 may be adjusted to provide a transmit signal of the required frequency. The output of the frequency multiplier 124 is fed to a variable gain amplifier 126 which may be adjusted to provide a transmit signal with the required amplitude. Variable gain amplifier 126 produces a transmit signal at its output which is fed to the directional coupler 106, via transmission line 108.

As noted above, the directional coupler 106 includes a reflected power port 118. In addition, the directional coupler 106 includes a forward power port 128. In this embodiment, the forward power port is not used, and port 128 is therefore terminated. Only the reflected power port 118 is coupled to the detector subsystem 104. However, in some of the embodiments described below, both of the ports are coupled to the detector subsystem 104.

Details of the detector subsystem 104 will now be described. In this embodiment, the signal processing within the detector subsystem 104 is implemented in the analogue domain. The reflected power port 118 of the directional coupler 106 is coupled to the detector subsystem 104 via transmission line 130. The detector subsystem 104 includes a band pass filter (BPF) 131. Transmission line 130 is coupled to an input of the BPF 131. The detector subsystem 104 also includes a logarithmic (log) RF power detector 132. An output of the BPF 131 is coupled to an input of the log RF power detector 132. The output of the log RF power detector 132 is coupled to a low pass filer (LPF) 134. The output of the LPF 134 is coupled to a high pass filter (HPF) 136.

The detector subsystem 104 also includes an amplifier 138, a voltage-to-frequency converter (VFC) 140 and a loudspeaker 142. The amplifier 138 includes an operational amplifier 144. The output of the HPF 136 is coupled to the inverting input 146 of the operational amplifier 144 via input resistor 148. A feedback resistor 150 is positioned in the feedback path between the operational amplifier's output and the inverting input 146. A fixed DC reference signal 152 is then applied to the non-inverting input 154 of the operational amplifier 144. The output of the operational amplifier is coupled to the VFC 140. The output of the VFC 140 is coupled to the loudspeaker 142.

The operation of the detector 100 will now be described.

The transmitter subsystem 102 is arranged to generate an RF signal which is radiated by the transmit loop antenna 110. In particular, the transmitter subsystem 102 is arranged to generate a continuous RF signal, rather than a pulsed signal. The transmit loop antenna 110 generates a radio frequency magnetic near-field. This magnetic near-field induces currents in elongate conductive objects, such as elongate object 120. The induced currents in the elongate object cause the object to re-radiate the signal as their own magnetic near-field. The transmit loop antenna 110 receives the magnetic near-field generated by the elongate object. This causes a change in power of the signal reflected by the transmit loop antenna 110. In FIG. 1, the object detector is shown in a position of approach to the elongate object 120.

The directional coupler 106 couples a portion of the power of the transmit signal to the forward power port 128. The reflected power port 118 receives a portion of the transmit signal reflected by the transmit loop antenna 110. Accordingly, as the reflected signal power varies as the object detector approaches an elongate object, the power of the signal emitted from the reflected power port 118 also varies. In addition, small changes in the power of the signal at the forward power port 128 occur as the object detector 100 moves towards, or away from, an elongate object. The power of the signals at the forward and the reflected power ports enables the return loss of the transmit loop antenna 110 to be calculated. Furthermore, because the power at the forward power port 128 varies marginally when compared with the power of the signal at the reflected power port 118, the change in power of the signal at the reflected power port provides an indication of the change in return loss. It will be appreciated that signal power at the reflected power port alone may thus be used to provide an indication that the object detector is moving in relation to an elongate object.

In the embodiment shown in FIG. 1, the power of the signal output from the reflected power port 118 varies as the object detector 100 moves towards, or away from, elongate object 120. Accordingly, the power of the input to the log RF power detector 132 varies. The log RF power detector 132 provides an output voltage that is proportional to the logarithm of the signal power from the reflected power port 118. This output voltage is therefore essentially equivalent to the return loss of the transmit loop antenna 110 over a large dynamic range.

The log RF power detector 132 is preceded by BPF 131. This filter has a pass band corresponding to the output frequency of the transmitter subsystem 102, and as such, it improves the ability of the system to reject external interference.

The movement towards, or away from, the elongate object causes power variations of the order of 0.5 dB at the input to the log RF power detector 132. The input signal to the log RF power detector also experiences a much slower variation due to the effect of temperature change on the impedance match of the transmit loop antenna 110. These variations due to temperature change are of the order of tens of dB. The log RF power detector 132 compresses the dynamic range of the signal, in order to maintain the small variations in the signal due to the movement of the detector in relation to the elongate object simultaneously in the presence of the much larger variations due to temperature changes.

The LPF 134 is used to the remove the high frequency noise components present in the output signal from the log RF power detector 132. The HPF 136 is used to remove the slow variations due to temperature drift. Once the signal has passed through the LPF 134 and the HPF 136, what remains, in terms of signal variation, is due to the movement of the detector in the vicinity of detectable objects. The HPF 136 prevents the large variations due to temperature drift from reaching amplifier 138. Amplifier 138 is therefore able to amplify the small variations due to the detectable object without saturating due to the larger variations from temperature drift.

The amplifier 138 superimposes the amplified signal variations due to the detectable object onto a fixed DC level from input 152. The resulting signal is used as an input to the VFC 140, which produces an audio frequency electrical signal. The frequency of this signal depends on the voltage at the input of VFC 140. The electrical signal is converted to an audible signal by loudspeaker 142. The fixed DC level at the output of amplifier 138 therefore causes the loudspeaker 142 to emit a tone of fixed pitch in the absence of any detectable objects.

When the detector approaches or passes over a detectable object, signal variations appear at the output of amplifier 138 as described above. These signal variations cause changes in the pitch of the audio tone generated by VFC 140 and loudspeaker 142. These changes in pitch, as opposed to the steady tone in the absence of a detectable object, are used to indicate the presence of the object.

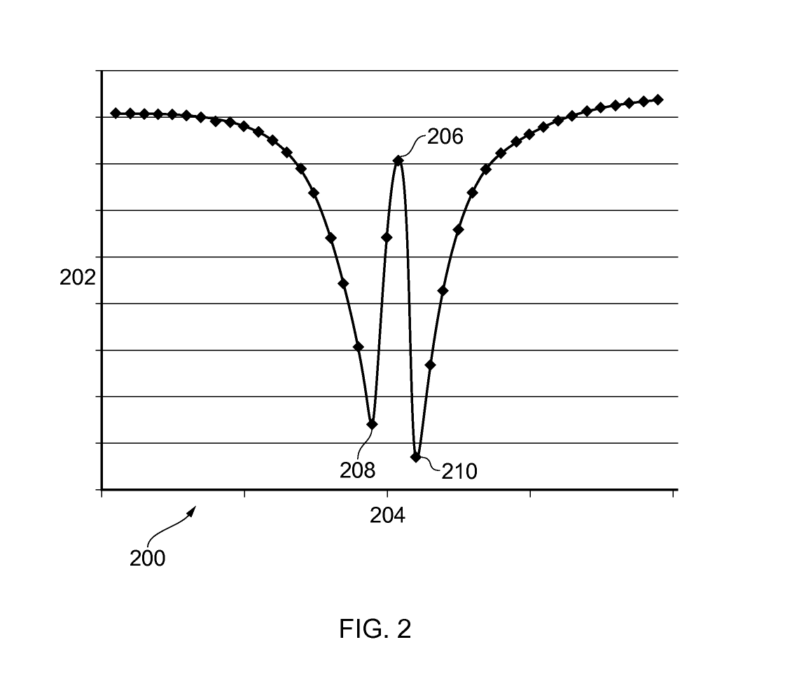

FIG. 2 is a plot 200 showing a typical example of the characteristic signature of an elongate detected object, when the object detector 100 moves over such an object. Reflected signal power or audio pitch 202 is shown on the y-axis and time or distance 204 is shown on the x-axis. The signal shown consists of a central positive peak 206 which occurs when the detector is directly over the elongate object, and two negative peaks 208, 210 at either side of the object. In terms of audio pitch, this therefore represents an initial fall in pitch, a rise in pitch, and then a fall in pitch. The operator learns to understand this pattern of pitch changes, and is then able to interpret the difference between changes due to elongate objects, and other changes resulting from the interaction between the detector 100 and the ground over which it moves. The operator is able to learn that the tone pattern depicted in FIG. 2 means that a detectable object has been passed over.

It should be noted that the pattern in FIG. 2 may be inverted in the y-axis, resulting in a central negative peak which occurs when the detector is directly over the elongate object, and two positive peaks at either side of the object.

It should also be noted that while, in this embodiment, the detector subsystem 104 generates a continuously variable tone, the circuit could be arranged to utilise a thresholding circuit, causing the loudspeaker 142 to generate a tone only when the power varies sufficiently to indicate the presence of a detectable object.

In the embodiment described above, the output of the detector is an audible tone. However, the detector may be arranged to produce alternative user perceivable outputs. For example, the output of the amplifier 138 could be connected to an oscilloscope, thereby providing a visual indication of the reflected power.

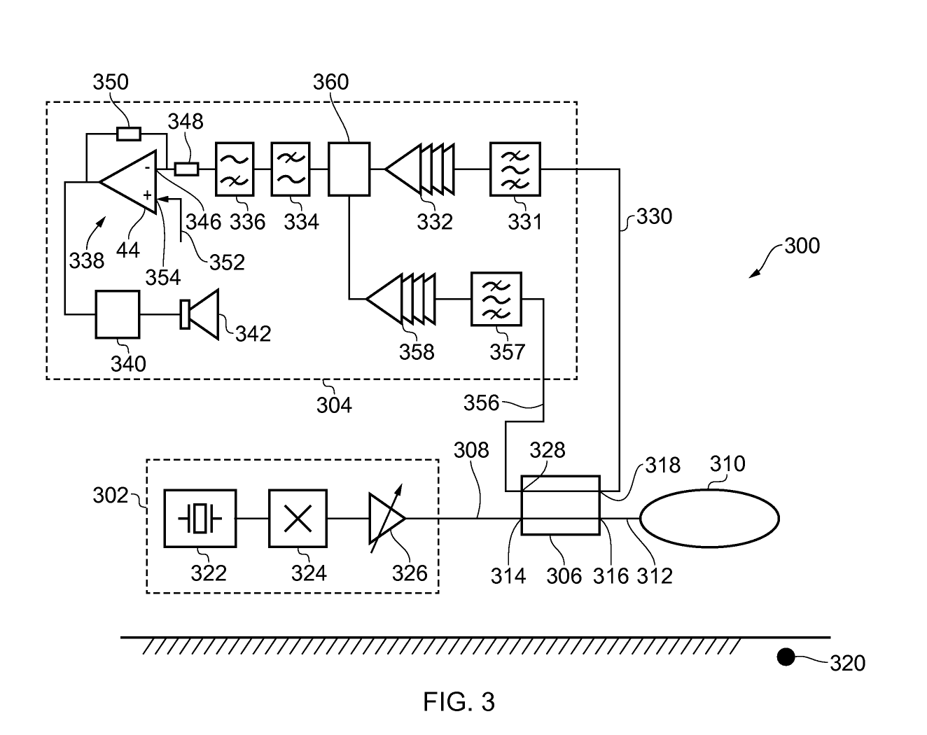

FIG. 3 is a schematic diagram of an object detector 300 in accordance with a second embodiment. The object detector 300 is substantially the same as detector 100, and most of the components are identified using corresponding reference numerals. However, for completeness, the detector 300 is described here in full, with the correct reference numerals. The object detector 300 includes a transmitter subsystem 302, and a detector subsystem 304.

An output of the transmitter subsystem 302 is coupled to a directional coupler 306, via transmission line 308, which is in turn coupled to a transmit loop antenna 310, via transmission line 312. The directional coupler 306 includes an input port 314 and an output port 316. The output of the transmitter subsystem 302 is coupled to the input port 314 of the directional coupler 306. The transmit loop antenna 310 is coupled to the output port 316 of the directional coupler 306. The directional coupler 306 also includes a reflected power port 318. The detector subsystem 304 is coupled to the reflected power port 318 of the directional coupler 306, as will be described in more detail below.

Transmit loop antenna 310 is arranged in the horizontal plane, i.e. the plane of the loop of the antenna is parallel to the surface of the ground surface. Furthermore, the loop is circular when viewed from above. However, other configurations are possible, as will be appreciated by the skilled person.

The transmitter subsystem 302 includes an oscillator 322 and a frequency multiplier 324. The transmit signal is generated by oscillator 322 and frequency multiplier 324. The oscillator 322 and frequency multiplier 324 may be adjusted to provide a transmit signal of the required frequency. The output of the frequency multiplier 324 is fed to a variable gain amplifier 326 which may be adjusted to provide a transmit signal with the required amplitude. Variable gain amplifier 326 produces a transmit signal at its output which is fed to the directional coupler 306, via transmission line 308.

As noted above, the directional coupler 306 includes a reflected power port 318. In addition, the directional coupler 306 includes a forward power port 328. In this embodiment, and in contrast to the previous embodiment, both ports are coupled to the detector subsystem 304.

Details of the detector subsystem 304 will now be described. In this embodiment, the signal processing within the detector subsystem 304 is implemented in the analogue domain. The reflected power port 318 of the directional coupler 306 is coupled to the detector subsystem 304 via transmission line 330. The detector subsystem 304 includes a band pass filter (BPF) 331. Transmission line 330 is coupled to the input of the BPF 331. The detector subsystem 304 also includes a log RF power detector 332. The output of the BPF 331 is coupled to the input of the log RF power detector 332. In this embodiment, instead of being terminated, the forward power port 328 of the directional coupler 306 is coupled to the detector subsystem 304 via transmission line 356. The detector subsystem 304 includes an additional band pass filter (BPF) 357. Transmission line 356 is coupled to the input of the BPF 357. The detector subsystem 304 also includes an additional log RF power detector 358. The output of the BPF 357 is coupled to the input of the log RF power detector 358.

The detector subsystem 304 also includes a subtraction circuit 360. The subtraction circuit 360 is coupled to the outputs of both log RF power detectors 332, 358. The output of the subtraction circuit 360 is coupled to a low pass filer (LPF) 334. The output of the LPF 334 is coupled to a high pass filer (HPF) 336.

The detector subsystem 304 also includes an amplifier 338, a voltage-to-frequency converter (VFC) 340 and a loudspeaker 342. The amplifier 338 includes an operational amplifier 344. The output of the HPF 336 is coupled to the inverting input 346 of the operational amplifier 344 via input resistor 348. A feedback resistor 350 is positioned in the feedback path between the operational amplifier's output and the inverting input 346. A fixed DC reference signal 352 is applied to the non-inverting input 354 of the operational amplifier 344. The output of the operational amplifier is coupled to the VFC 340. The output of the VFC 340 is coupled to the loudspeaker 342.

The operation of the detector 300 will now be described.

The transmitter subsystem 302 is arranged to generate an RF signal which is radiated by the transmit loop antenna 310. In particular, the transmitter subsystem 302 is arranged to generate a continuous RF signal. The transmit loop antenna 310 generates a radio frequency magnetic near-field. This magnetic near-field induces currents in elongate conductive objects, such as elongate object 320. The induced currents in the elongate object cause the object to re-radiate the signal as their own magnetic near-field. The transmit loop antenna 310 receives the magnetic near-field generated by the elongate object. This causes a change in power of the signal reflected by the transmit loop antenna 310. In FIG. 3, the object detector is shown in a position of approach to the elongate object 320.

The directional coupler 306 couples a portion of the power of the transmit signal to the forward power port 328. The reflected power port 318 receives a portion of the transmit signal reflected by the transmit loop antenna 310. Accordingly, as the reflected signal power varies as the object detector approaches an elongate object, the power of the signal emitted from the reflected power port 318 also varies. In addition, small changes in the power of the signal at the forward power port 328 occur as the object detector 300 moves towards, or away from, an elongate object. The power of the signals at the forward and the reflected power ports enables the return loss of the transmit loop antenna 310 to be calculated.

In the embodiment shown in FIG. 3, the power of the signal output from the reflected power port 318 varies as the object detector 300 moves towards, or away from, elongate object 320. Accordingly, the power of the input to the log RF power detector 332 varies. The log RF power detector 332 provides an output voltage that is proportional to the logarithm of the signal power from the reflected power port 318. As described above, small changes also occur in the power of the signal output from the forward power port 328 as the object detector 300 moves towards, or away from, elongate object 320. Accordingly, the power of the input to the log RF power detector 358 varies. The log RF power detector 358 provides an output voltage that is proportional to the log of the forward power from the forward power port 328.

The log RF power detector 332 is preceded by BPF 331. Similarly the log RF power detector 358 is preceded by BPF 357. These filters have a pass band corresponding to the output frequency of the transmitter subsystem 302, and as such, they improve the ability of the system to reject external interference.

The subtraction circuit 360 subtracts the voltage representing the reflected power at the output of log. detector 332 from the voltage representing the forward power at the output of log. detector 358. The resulting output voltage represents the return loss of the transmit loop antenna 310 over a large dynamic range.

The output of the subtraction circuit 360 is coupled to LPF 334. The detector subsystem 304 then operates in the same manner as the detector subsystem 104. In contrast to detector 100, detector 300 utilises forward power as well as reflected power. This results in the output tone of the loudspeaker having a more accurate relationship to the true value of return loss.

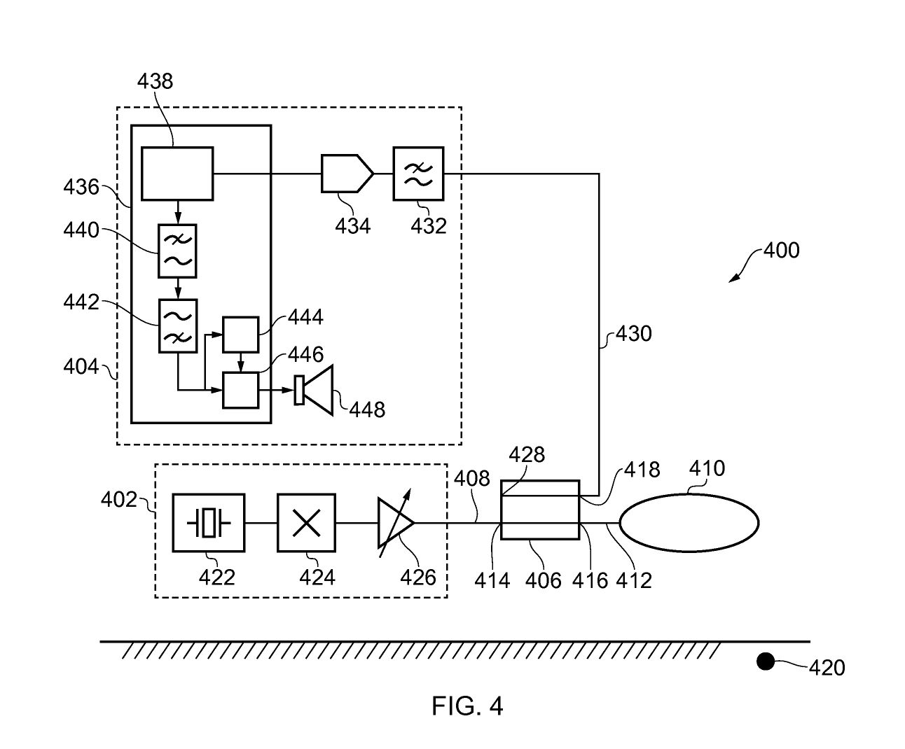

FIG. 4 is a schematic diagram of an object detector 400 in accordance with a third embodiment. In this embodiment, the signal processing within the detector subsystem is implemented in the digital domain. The transmitter subsystem is essentially the same as that used in the first embodiment, but is described here for completeness. The object detector 400 includes a transmitter subsystem 402 and a detector subsystem 404.

An output of the transmitter subsystem 402 is coupled to a directional coupler 406, via transmission line 408, which is in turn coupled to a transmit loop antenna 410, via transmission line 412. The directional coupler 406 includes an input port 414 and an output port 416. The output of the transmitter subsystem 402 is coupled to the input port 414 of the directional coupler 406. The transmit loop antenna 410 is coupled to the output port 416 of the directional coupler 406. The directional coupler 406 also includes a reflected power port 418. The detector subsystem 404 is coupled to the reflected power port 418 of the directional coupler 406, as will be described in more detail below.

Transmit loop antenna 410 is arranged in the horizontal plane, i.e. the plane of the loop of the antenna is parallel to the surface of the ground surface. Furthermore, the loop is circular when viewed from above. However, other configurations are possible, as will be appreciated by the skilled person.

The transmitter subsystem 402 includes an oscillator 422 and a frequency multiplier 424. The transmit signal is generated by oscillator 422 and frequency multiplier 424. The oscillator 422 and frequency multiplier 424 may be adjusted to provide a transmit signal of the required frequency. The output of the frequency multiplier 424 is fed to a variable gain amplifier 426 which may be adjusted to provide a transmit signal with the required amplitude. Variable gain amplifier 426 produces a transmit signal at its output which is fed to the directional coupler 406, via transmission line 408.

As noted above, the directional coupler 406 includes a reflected power port 418. In addition, the directional coupler 406 includes a forward power port 428. In this embodiment, the forward power port is not used, and port 428 is therefore terminated. Only the reflected power port 418 is coupled to the detector subsystem 404. However, in some of the embodiments described below, both of the ports are coupled to the detector subsystem 404.

Details of the detector subsystem 404 will now be described. In this embodiment, the signal processing within the detector subsystem 404 is implemented in the digital domain. The detector subsystem 404 is coupled to the directional coupler 406 via transmission line 430. Specifically, transmission line 430 is coupled to the reflected power port 418 of the directional coupler 406. The detector subsystem 404 includes an anti-alias filter 432. The transmission line 430 is coupled to the input of the anti-alias filter 432, and hence the reflected power port 418 is coupled to the input of the anti-alias filter 432. The detector subsystem 404 also includes an analogue to digital converter (ADC) 434. The output of the anti-alias filter 432 is coupled to the input of the ADC 434.

The detector subsystem 404 includes a digital processing system (DPS) 436. The DPS 436 includes a power measurement unit 438. The output of the ADC 434 is coupled to the input of the power measurement unit 438. The DPS 436 also includes a low pass filter (LPF) 440 and a high pass filter (HPF) 442. The output of power measurement unit 438 is coupled to the input of LPF 440. The output of LPF 440 is coupled to the input of HPF 442. The output of the HPF 442 is fed to a thresholder 444 and an audio oscillator 446. The output of the audio oscillator 446 is coupled to a loudspeaker 448.

The operation of the object detector shown in FIG. 4 will now be described.

The transmitter subsystem 402 is arranged to generate an RF signal which is radiated by the transmit loop antenna 410. In particular, the transmitter subsystem 402 is arranged to generate a continuous RF signal. The transmit loop antenna 410 generates a radio frequency magnetic near-field. This magnetic near-field induces currents in elongate conductive objects, such as elongate object 420. The induced currents in the elongate object cause the object to re-radiate the signal as their own magnetic near-field. The transmit loop antenna 410 receives the magnetic near-field generated by the elongate object. This causes a change in power of the signal reflected by the transmit loop antenna 410. In FIG. 4, the object detector 400 is shown in a position of approach to an elongate object 420.

The directional coupler 406 couples a portion of the power of the transmit signal to the forward power port 428. The reflected power port 418 receives a portion of the transmit signal reflected by the transmit loop antenna 410. Accordingly, as the reflected signal power varies as the object detector approaches an elongate object, the power of the signal emitted from the reflected power port 418 also varies. In addition, small changes in the power of the signal at the forward power port 428 occur as the object detector 400 moves towards, or away from, an elongate object. The power of the signals at the forward and the reflected power ports enables the return loss of the transmit loop antenna 410 to be calculated. Furthermore, because the power at the forward power port 428 varies marginally when compared with the power of the signal at the reflected power port 418, the change in power of the signal at the reflected power port provides an indication of the change in return loss. It will be appreciated that signal power at the reflected power port alone may thus be used to provide an indication that the object detector is moving in relation to an elongate object.

In the embodiment shown in FIG. 4, the power of the signal output from the reflected power port 418 varies as the object detector 400 moves towards, or away from, elongate object 420. Accordingly, the power of the inputs to the anti-alias filter 432 and ADC 434 varies. The anti-alias filter 432 and the ADC 434 together serve to sample the analogue signal generated by the directional coupler in order to generate a digital signal.

The digital signal from the ADC 434 is processed within the DPS 436. The DPS may be implemented as a field-programmable gate array (FPGA), a microcontroller, personal computer, or combination thereof. The power measurement unit 438 calculates the power of the reflected signal from the voltage samples generated at the output of the ADC 434. This calculation uses a Fast Fourier Transform (FFT) which selects only the frequency component corresponding to the output of the transmitter subsystem 402, thereby improving the ability of the system to reject external interference.

The filters LPF 440 and HPF 442 serve the same purpose as the LPFs and HPFs of the first embodiment. In particular, the LPF 440 removes high frequency noise components. The HPF 442 is used to remove slow variations due to temperature drift.

As the detector 400 moves in relation to detectable object 420, the reflected signal power, and hence the output from power measurement unit 438 increases and decreases. As described above, the LPF 440 and the HPF 442 remove noise and slow signal variations due to temperature drift. Accordingly, only variations owing to changes in reflected power due to detectable objects are passed by the filters.

The detector 400 may operate in two primary modes. In a first mode, the audio oscillator 446 may directly convert the output from the HPF 442 into an audio tone. The oscillator 446 causes the loudspeaker 448 to output an audio tone that varies in pitch as reflected signal power varies. Hence, the pitch of the tone varies as the detector moves in relation to a detectable object. In a second mode, the audio oscillator 446 produces a tone based on the output of thresholder 444. The thresholder 444 is also coupled to the output of the HPF 442. The thresholder 444 is arranged to produce an output when the power of the reflected signal increases above (or decreases below) a particular value, which may be predetermined by the operator. The audio oscillator 446 is arranged to produce a tone when it receives a signal from the thresholder 444. As an alternative, the thresholder 444 could be arranged to generate a signal when the rate of change of the reflected signal power increases above a particular rate of change.

The detector 400 may also be set up to provide alternative user perceivable outputs. For example, the output may be visual. The detector 400 may include a display. The display could be arranged to show a visual indication of signal power, or show when the signal power goes above the predetermined threshold.

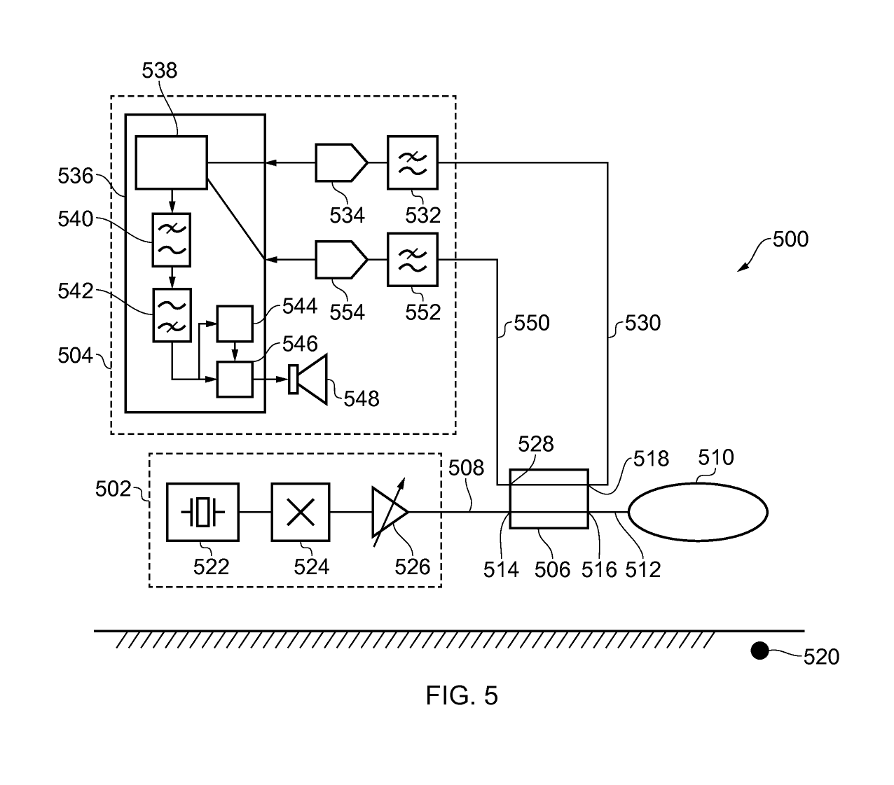

A fourth embodiment will now be described in relation to FIG. 5. FIG. 5 is a schematic diagram of an object detector 500 in accordance with a fourth embodiment. In this embodiment, the signal processing within the detector subsystem is implemented in the digital domain, in a similar way to the previous embodiment. The transmitter subsystem is essentially the same as that used in the first embodiment, but is described here for completeness. Where features correspond to those shown in FIG. 4, corresponding reference numerals as used. The object detector 500 includes a transmitter subsystem 502 and a detector subsystem 504.

The output of the transmitter subsystem 502 is coupled to a directional coupler 506, via transmission line 508, which is in turn coupled to a transmit loop antenna 510, via transmission line 512. The directional coupler 506 includes an input port 514 and an output port 516. The output of the transmitter subsystem 502 is coupled to the input port 514 of the directional coupler 506. The transmit loop antenna 510 is coupled to the output port 516 of the directional coupler 506. The directional coupler 406 also includes a reflected power port 518 and a forward power port 528.

Transmit loop antenna 510 is arranged in the horizontal plane, i.e. the plane of the loop of the antenna is parallel to the surface of the ground surface. Furthermore, the loop is circular when viewed from above. However, other configurations are possible, as will be appreciated by the skilled person.

As noted above, the directional coupler 506 includes a reflected power port 518 and a forward power port 528. In this embodiment, and in contrast to the previous embodiment, both ports are coupled to the detector subsystem 504.

Details of the detector subsystem 504 will now be described. In this embodiment, the signal processing within the detector subsystem 504 is implemented in the digital domain. The detector subsystem 504 is coupled to the directional coupler 506 via transmission line 530. Specifically, transmission line 530 is coupled to the reflected power port 518 of the directional coupler 506. The detector subsystem 504 includes an anti-alias filter 532. The transmission line 530 is coupled to the input of the anti-alias filter 532, and hence the reflected power port 518 is coupled to the input of the anti-alias filter 532. The detector subsystem 504 also includes an analogue to digital converter (ADC) 534. The output of the anti-alias filter 532 is coupled to in the input of the ADC 534.

In this embodiment, the detector subsystem 504 is additionally coupled to the directional coupler 506 by transmission line 550. Specifically, and in contrast to the previous embodiment, transmission line 550 is coupled to the forward power port 528 of the directional coupler 506. In this embodiment, the detector subsystem 504 includes a second anti-alias filter 552. The transmission line 550 is coupled to the input of the anti-alias filter 552, and hence the forward power port 528 is coupled to the input of the anti-alias filter 552. In this embodiment, the detector subsystem 504 includes a second ADC 554. The output of the anti-alias filter 552 is coupled to the input of the ADC 554.

The detector subsystem 504 includes a digital processing system (DPS) 536. The DPS 536 includes a power measurement unit 538. The output of the ADC 534 is coupled to the input of the power measurement unit 538. In this embodiment, the output of ADC 554 is coupled to a second input of the power measurement unit 438. The DPS 436 also includes a low pass filter (LPF) 540 and a high pass filter (HPF) 542. The output of power measurement unit 538 is coupled to the input of LPF 540. The output of LPF 540 is coupled to the input of HPF 542. The output of the HPF 542 is fed to a thresholder 544 and an audio oscillator 546. The output of the audio oscillator 546 is coupled to a loudspeaker 548.

The operation of the object detector shown in FIG. 5 will now be described.

The transmitter subsystem 502 is arranged to generate an RF signal which is radiated by the transmit loop antenna 510. In particular, the transmitter subsystem 502 is arranged to generate a continuous RF signal. The transmit loop antenna 510 generates a radio frequency magnetic near-field. This magnetic near-field induces currents in elongate conductive objects, such as elongate object 520. The induced currents in the elongate object cause the object to re-radiate the signal as their own magnetic near-field. The transmit loop antenna 510 receives the magnetic near-field generated by the elongate object. This causes a change in power of the signal reflected by the transmit loop antenna 510. In FIG. 5, the object detector is shown in a position of approach to an elongate object 520.

The directional coupler 506 couples a portion of the power of the transmit signal to the forward power port 528. The reflected power port 518 receives a portion of the transmit signal reflected by the transmit loop antenna 510. Accordingly, as the reflected signal power varies as the object detector approaches an elongate object, the power of the signal emitted from the reflected power port 518 also varies. In addition, small changes in the power of the signal at the forward power port 528 occur as the object detector 500 moves towards, or away from, an elongate object. The power of the signals at the forward and the reflected power ports enables the return loss of the transmit loop antenna 510 to be calculated.

In the embodiment shown in FIG. 5, the power of the signal output from the reflected power port 518 varies as the object detector 500 moves towards, or away from, elongate object 520. Accordingly, the power of the inputs to the anti-alias filter 532 and ADC 534 varies. As described above, small changes also occur in the power of the signal output from forward power port 528 as the object detector 500 moves towards, or away from, elongate object 520. Accordingly, the power of the inputs to the anti-alias filter 552 and ADC 554 varies. The anti-alias filters and the ADCs together serve to sample the analogue signals generated by the directional coupler in order to generate digital signals at their outputs.

The digital signals from the ADCs 534 and 554 are processed within the DPS 436. The DPS may be implemented as a field-programmable gate array (FPGA), a microcontroller, personal computer, or combination thereof. In this embodiment, the power measurement unit 538 is arranged to calculate the return loss from the forward and reflected voltage samples generated at the output of the ADCs 554 and 534. This calculation uses a Fast Fourier Transform (FFT) which selects only the frequency component corresponding to the output of the transmitter subsystem 502, thereby improving the ability of the system to reject external interference. The use of both the forward and reflected samples results in a more accurate representation of return loss, as opposed to the approach taken in the previous embodiment, where only the reflected power is calculated, which represents an approximation to the return loss.

The filters LPF 540 and HPF 542 serve the same purpose as the LPFs and HPFs of the first embodiment. In particular, the LPF 540 removes high frequency noise components. The HPF 542 is used to remove slow variations due to temperature drift.

As the detector 500 moves in relation to detectable object 520, the return loss, and hence the output from power measurement unit 538 increases and decreases. As described above, the LPF 540 and the HPF 542 remove noise and slow signal variations due to temperature drift. Accordingly, only variations owing to changes in reflected power due to detectable objects are passed by the filters.

The detector 500 may operate in two primary modes. In a first mode, the audio oscillator 546 may directly convert the output from the HPF 542 into an audio tone. The oscillator 546 causes the loudspeaker 548 to output an audio tone that varies in pitch as reflected signal power varies. Hence, the pitch of the tone varies as the detector moves in relation to a detectable object. In this embodiment, the tone has a more accurate relationship to the true return loss, when compared to the previous embodiment, in which only the reflected power signal was used.

In a second mode, the audio oscillator 546 produces a tone based on the output of thresholder 544. The thresholder 544 is also coupled to the output of the HPF 542. The thresholder 544 is arranged to produce an output when the return loss increases above (or decreases below) a particular value, which may be predetermined by the operator. The audio oscillator 546 is arranged to produce a tone when it receives a signal from the thresholder 544. As an alternative, the thresholder 544 could be arranged to generate a signal when the rate of change of the return loss increases above a particular rate of change.

The detector 500 may also be set up to provide alternative user perceivable outputs. For example, the output may be visual. The detector 500 may include a display. The display could be arranged to show a visual indication of signal power, or show when the signal power goes above the predetermined threshold.

In the above described embodiments, the transmit loop antenna 110, 310, 410, 510 is a tuned loop. The loop antenna 110, 310, 410, 510 has an inductance which is related to its physical dimensions. The loop is tuned to the transmit frequency with a capacitor connected in parallel with the loop (not shown) to form an LC tuned circuit which is resonant at the transmit frequency. For best performance the Quality Factor (Q) of the tuned circuit should be high, at least 10 and preferably greater than 60.

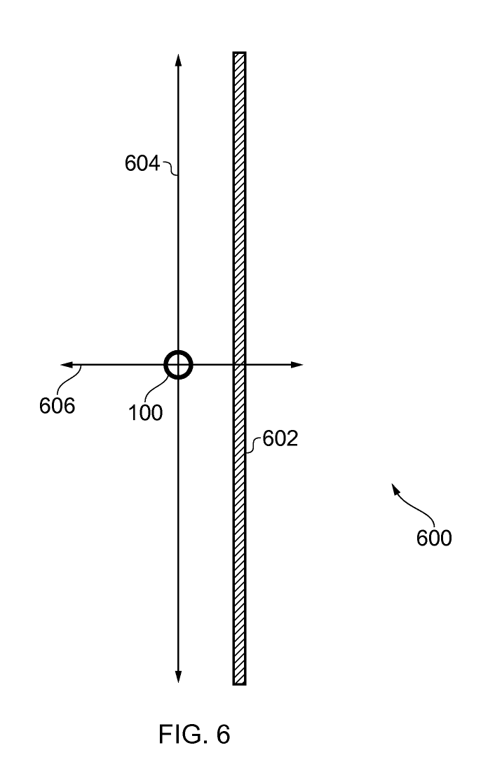

FIG. 6 shows a plan view of an open area 600 under which an elongate conductive object 602 is buried. The arrows 604, 606 show the area in which the detector 100, 300, 400, 500 may be positioned in order to detect the object 602. The detector 100, 300, 400, 500 is most effective when positioned halfway along the buried object 602.

Furthermore, the detector 100, 300, 400, 500 is most effective when the object 602 has a length which is half a wavelength, taking into account the dielectric effects of the ground, at the operating frequency of the detector 100, 300, 400, 500. FIG. 6 is not to scale.

As noted above, when a detector moves towards or away from an elongate conductive object, the power of the signal reflected by the loop antenna varies. Accordingly, by monitoring the output of the reflected power port, the detector is able to generate a signal that represents reflected signal power. Using power calculations based on both reflected and forward power, the detector subsystem is able to determine return loss. A change in return loss indicates the presence of a detectable object, and can be used to alert an operator to the presence of the object. As has been discussed above, this may be done by using a return loss threshold value, or may be done using an audible tone that varies in pitch depending on the calculated return loss. In an alternative embodiment, the detector subsystem may be coupled to the reflected power port but not the forward power port. This is because the forward power only changes to a small degree when a detectable object is approached, whereas reflected power changes substantially. Accordingly, the reflected power gives an indication of return loss, and may be used on its own. Using forward power serves to improve the accuracy of the return loss calculation.

In the embodiment described in connection with FIG. 4, the signal processing within the object detector 400 is implemented in the digital domain, and object detection may be done using threshold detection, or may be done using an audio signal, which an operator is trained to listen to and interpret. It will be appreciated that either threshold detection or audible detection may be used in either the digital domain or the analogue domain.

In the above-described embodiments, the detector has been described as detecting return loss. It will be appreciated by a person skilled in the art that changes in return loss are as a result of changes in the impedance of the antenna. The impedance changes are as a result of the presence of detectable objects near to the antenna. These impedance changes may occur to both the real and imaginary parts of the antenna impedance. As such they manifest as changes in both the magnitude and phase of the voltage reflection coefficient. In the above described embodiments, the measurement is equivalent to return loss and detects magnitude changes in the reflection coefficient. However it will be appreciated that an alternative method of detection, by measuring changes in the phase of the voltage reflection coefficient, is also possible.

In the above-described embodiments, the transmitter subsystem has been described as generating a continuous signal. In this context, a continuous signal is one that is not pulsed. However, it will be appreciated that the continuous signal may be turned off, and back on, from time-to-time. For example, this may be done as a method of reducing average system power consumption. The present embodiments do not however require the signal to be pulsed in order to function.

There are three notable differences between the present embodiments and RADAR-type systems. Firstly, in the present embodiments, the continuous transmit signal generates a continuous magnetic field, which may be continuously monitored by detector subsystem. That is to say, the system is transmitting and receiving at the same time on a continuous basis. The reception of the magnetic near-field from the elongate object, and that from the transmit loop, occurs at a similar point in time with negligible delay. This is in contrast to a RADAR-type system, in which a signal pulse is generated, and after a time period corresponding to the return propagation delay, the pulse is received. The propagation delay in such a system is significant and measurable. The RADAR-type system determines the presence of the target from the time delay, and other characteristics, of the received signal. Most notably and in contrast to the present embodiments, the RADAR-type system transmits and receives at separate instances in time.

Secondly, there is a difference relating to the RF wavelength in use. In a RADAR-type systems, the distance to the target is long compared to the wavelength. This is in contrast to the present embodiments, where the distance between the system and the object is short compared to the wavelength.

Thirdly, there is a difference in the RF field distribution. A RADAR-type system uses a freely propagating electromagnetic wave, in which the electric and magnetic components exist at a constant ratio, which is independent of distance. This is a consequence of the system operating in the far-field, with several cycles of the wave existing between the system and the target. In the present embodiments, the situation is quite different. Firstly, only the magnetic component of the RF field is used. Secondly, this component is utilised in the near-field region, where the relationship between the electric and magnetic components of the field varies with position with respect to the loop antenna and the elongate conducting object.

It will be understood that the term “object detector” refers to a device capable of generating a signal that changes in response to the movement of the device in relation to a detectable object. That signal may either be interpreted by a user, or it may be used by the detector to indicate the present of an object. In other words, when the user interprets the signal, the user is doing the “detection”. Whereas, when the device interprets the signal (for example using thresholds), the device does the “detection”. In either event, the object detector is still referred to as a “detector”.

In the above-identified embodiments, a directional coupler has been used to provide the detector subsystem with forward and reverse signals. Alternatively, a diode detector could be used.

In the above-identified embodiments, the detector subsystem uses signal power, or return loss, to generate a detection signal. Alternatively, signal amplitude or phase may be used to generate the detection signal.

The above-described embodiments are described as examples. The skilled person will appreciate that variations may be made without departing from the spirit and scope of the disclosure.

While the claims provide for a particular combination of features, the skilled person will appreciate that other combinations are possible.

1. An object detector for detecting elongate conductive objects, comprising:
a transmitter arranged to generate a transmit signal; and
a transmit antenna, coupled to said transmitter and arranged to radiate said transmit signal; wherein
the object detector is arranged to generate a detection signal, the detection signal being based on at least one characteristic of a portion of the transmit signal reflected by the transmit antenna; and
the at least one characteristic of the portion of the transmit signal reflected by the transmit antenna changes in response to movement of the detector in relation to a detectable object.

2. An object detector according to claim 1, wherein the object detector is arranged to generate a user perceivable output, corresponding to the detection signal.

3. An object detector according to claim 2, further comprising a loudspeaker, wherein the user perceivable output is an audio tone generated by the loudspeaker; and further comprising an audio oscillator, arranged to receive the detection signal, and coupled to the loudspeaker, wherein the audio oscillator is arranged to produce an output that causes the loudspeaker to generate an audio tone whose pitch varies in response to changes in the detection signal.

4. An object detector according to claim 3, further comprising a thresholder, coupled to the loudspeaker and arranged to receive said detection signal, and arranged to generate an output when the detection signal exceeds a predetermined value, wherein the loudspeaker is arranged to generate an audio tone when the detection signal increases above or decreases below a predetermined value.

5. An object detector according to claim 1, further comprising:
a directional coupler, coupled to the transmitter and the transmit antenna and having a reflected power port; wherein:
said portion of the transmit signal reflected by the transmit antenna is outputted from said reflected power port; and
the directional coupler comprises an input port, coupled to the transmitter, and an output port, coupled to the transmit antenna.

6. An object detector according to claim 5, wherein the detection signal is based on at least one characteristic of the portion of the transmit signal outputted from the reflected power port, and the at least one characteristic of the portion of the transmit signal outputted from the reflected power port changes in response to movement of the detector in relation to a detectable object.

7. An object detector according to claim 5, wherein said directional coupler further comprises a forward power port; wherein
said directional coupler is arranged to output a portion of the transmit signal from said forward power port; and
the detection signal is also based on at least one characteristic of the portion of the transmit signal outputted from the forward power port.

8. An object detector according to claim 1, further comprising a diode detector.

9. An object detector according to claim 1, wherein the detection signal is also based on at least one characteristic of a portion of the transmit signal, and the at least one characteristic of a portion of the transmit signal also changes in response to movement of the detector in relation to a detectable object.

10. An object detector according to claim 1, wherein the detection signal corresponds to a return loss of the transmit antenna.

11. An object detector according to claim 1, wherein the at least one characteristic is one of: amplitude, power or phase of the signals.

12. An object detector according to claim 1, further comprising one or more analogue circuit components, wherein the detection signal is generated by said components.

13. An object detector according to claim 12, further comprising a logarithmic RF power detector, arranged to generate a signal corresponding to the power of the portion of the transmit signal reflected by the transmit antenna; and an amplifier, coupled to the logarithmic RF power detector, and arranged to generate said detection signal.

14. An object detector according to claim 1, further comprising one or more digital circuit components, wherein the detection signal is generated by said components.

15. An object detector according to claim 1, wherein the object detector is further arranged to calculate return loss based on power of a portion of the transmit signal reflected by the transmit antenna and power of a portion of the transmit signal.

16. An object detector according to claim 1, wherein said transmitter is arranged to generate a continuous transmit signal.

17. An object detector according claim 1, further arranged to determine when the at least one characteristic of a portion of the transmit signal reflected by the transmit antenna exceeds a predetermined threshold.

18. An object detector according to claim 1, wherein the detector is for detecting buried objects.

19. An object detector according to claim 1, wherein said transmit antenna is a loop antenna and is orientated such that, in use, the primary plane of the loop is substantially horizontal to ground; the transmit antenna is a tuned loop resonant at a frequency of operation; and the tuned loop has a Q of 10 or more.

20. An object detector according to claim 19, wherein said loop antenna is further arranged to generate a continuous magnetic near-field, and at least one characteristic of the portion of the transmit signal reflected by the transmit antenna changes in response to the magnetic near-field re-radiated by any detectable objects within range of the object detector, and received by the transmit antenna.

21. A method of elongate conductive object detection using an object detector comprising: a transmitter arranged to generate a transmit signal; and a transmit antenna, coupled to said transmitter and arranged to radiate said transmit signal; the method comprising:
generating and transmitting said transmit signal; and
generating a detection signal, the detection signal being based on at least one characteristic of a portion of the transmit signal reflected by the transmit antenna, wherein the at least one characteristic of the portion of the transmit signal reflected by the transmit antenna changes in response to movement of the detector in relation to a detectable object.

22. A method according to claim 21, further comprising: moving the object detector in relation to a detectable object.
